(19) United States
(12) Patent Application Publication
(10) Pub. No.: US 2011/0247154 A1
(43) Pub. Date: Oct. 13, 2011

(54) Electric Toothbrush And Brush Head Therefor

(75) Inventors: Georges Driesen, Weilrod (DE); Michael Schmid, Frankfurt/Main (DE); Norbert Schaefer, Frankfurt/Main (DE); Hansjoerg Reick, Cincinnati, OH (US); Stefan Schamberg, Usingen (DE); Eva Susanne Thurnay, Frankfurt/Main (DE); Rory McGarry, Frankfurt/Main (DE)

(73) Assignee: Braun GmbH, Cincinnati, OH (US)

(21) Appl. No.: 13/101,447

(22) Filed: May 5, 2011

(30) Foreign Application Priority Data
Nov. 5, 2008 (EP) 08019351.9
Nov. 4, 2009 (IB) PCT/IB2009/054904

(51) Int. Cl. A61C 17/34

(52) U.S. Cl. 15/22.1

(57) ABSTRACT

A brush head for an electric toothbrush is disclosed. The brush head includes a substantially plate-shaped bristle support carrying a bristle field, the bristle field having a main axis extending substantially perpendicularly to the bristle support and including a plurality of bristles defining with their free ends a flat or concave working surface to be put onto the teeth to be cleaned; driving and/or transmitting means for driving the bristle support using a reciprocating poking motion along a poking axis and an oscillatory rotational motion about an axis of rotation; and connecting means for connecting the bristle support with a toothbrush handpiece such that a brush head longitudinal axis extends substantially parallel to a toothbrush handpiece longitudinal axis in connected condition. The bristle field with its bristle field main axis is arranged at a tilt relative to the brush head longitudinal axis such that the bristle field main axis is inclined at an acute angle of inclination (Φ) to a perpendicular upon the brush head longitudinal axis, and wherein a working surface is inclined in opposite direction to the tilt of the bristle field main axis such that a plane lying onto the working surface is sloped at an acute angle to a plane perpendicular to the bristle field main axis.

### CROSS REFERENCE TO RELATED APPLICATIONS

This application is a continuation of International Application No. PCT/IB2009/054904, filed Nov. 4, 2009, which claims priority to EP 08019351.9 filed Nov. 5, 2008, the substance of which is incorporated herein by reference in its entirety

### FIELD OF THE INVENTION

The present disclosure relates to an electric toothbrush and a brush head therefore.

### BACKGROUND OF THE INVENTION

Electric toothbrushes regularly possess bristle supports adapted to be driven in an oscillatory rotational motion and having bristle fields mounted thereon whose main axis extends approximately at right angles to the toothbrush longitudinal axis which is defined by the toothbrush handpiece. In use, the rotation about an axis of rotation in the center of the brush head results in an automatic centering of the brush head around the respective tooth to be cleaned. The bristle tufts farthest away from the axis of rotation in the toothbrush longitudinal direction move back and forth in the hollows between two teeth or the interproximal spaces, while the axis of rotation in the middle of the bristle field is directed centrally at the corresponding tooth flank. Such a centering effect results in particular when the circumferential bristles of the bristle field are higher or the bristle field has a depression in its center. Such a toothbrush is disclosed, for example, in EP 0835081 B1.

To improve, for example, the cleansing of interproximal spaces and to dislodge plaque better, it is known in this context to drive the bristle field not only in an oscillatory rotational motion but also in a reciprocating poking motion substantially parallel to the bristle field main axis. If such a poking motion takes place in addition to the oscillatory rotational motion, the term 3D toothbrush is conventionally used, meaning a spatially or multidimensionally drivable bristle field, because the bristle tips move in the space in all three dimensions. Such a combined spatial movement of the bristle field has the above-mentioned self-centering effect and has proved more effective regarding the cleansing performance.

However, such a poking motion in the direction of the bristle field main axis tends to produce relatively high forces which act on the tooth surfaces and the gums, which is sometimes perceived as unpleasant because the poking motion is performed substantially in the form of prodding motions at right angles to the gums. To produce no unpleasant cleaning sensation in this regard, it has been suggested to limit the amplitude of the poking motion, in actual fact making it very small. However, this leads again to a reduced brushing efficiency because the depth of penetration into the interproximal spaces remains relatively limited.

As an alternative to such brush heads using poking motions substantially parallel to the bristle field main axis, toothbrushes have been proposed which have an eccentric drive in the brush head and an inclined brush head, thereby causing the brush head and also the bristles to move on an orbital path or an ellipse. Because there is no axis of rotation in the center of the brush head about which the head oscillates in a rotary movement, such toothbrushes do not enjoy the initially mentioned self-centering effect. Already in the presence of a low contact pressure the toothbrush dances around on the teeth in all directions and is difficult to position. At a higher contact pressure, even the cleansing performance drops sharply as a result of the drive, making it necessary for the brush head to be moved across the teeth using back and forth movements as with a manual toothbrush. Obviously, any centering of the brush head relative to the tooth via an axis of rotation in the center of the bristle field is then out of the question.

For toothbrushes or brush heads which use an oscillatory rotational motion about an axis of rotation and an additional poking motion in the direction of this axis of rotation, the use of thinner bristles has been proposed for producing a “softer” cleaning sensation, bristles which bend much more easily as a result of which the prodding motions perpendicularly to the gums are perceived as less discomforting. However, by reducing the bristle diameter in this way, their cleansing efficiency drops dramatically when these bristles are guided across the tooth surface in bent condition—which is regularly the case. Insofar, this reduced-diameter approach offers no solution for the mentioned dilemma either, according to which on the one hand the use of poking motions of a sufficiently high amplitude in the presence of sufficient cleaning forces should produce a good cleaning effect while on the other hand the cleaning process is gentle on the gums.

As a result, there is a need to provide an improved electric toothbrush and an improved brush head therefore, resulting in an effective dental cleaning action that reaches deep into interproximal spaces and while at the same time providing a gentle cleaning sensation without sacrificing the self-centering effect of the movement of the bristle field.

### SUMMARY OF THE INVENTION

In one embodiment, a brush head for an electric toothbrush is provided. The brush head includes a substantially plate-shaped bristle support carrying a bristle field, the bristle field having a main axis extending substantially perpendicularly to the bristle support and including a plurality of bristles defining with their free ends a flat or concave working surface to be put onto the teeth to be cleaned; driving and/or transmitting means for driving the bristle support using a reciprocating poking motion along a poking axis and an oscillatory rotational motion about an axis of rotation; and connecting means for connecting the bristle support with a toothbrush handpiece such that a brush head longitudinal axis extends substantially parallel to a toothbrush handpiece longitudinal axis in connected condition. The bristle field with its bristle field main axis is arranged at a tilt relative to the brush head longitudinal axis such that the bristle field main axis is inclined at an acute angle of inclination (Φ) to a perpendicular upon the brush head longitudinal axis, and wherein a working surface is inclined in opposite direction to the tilt of the bristle field main axis such that a plane lying onto the working surface is sloped at an acute angle to a plane perpendicular to the bristle field main axis.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1 is a schematic side view of an electric toothbrush having a rotationally drivable brush head according to an embodiment shown and illustrated herein;

FIG. 2 is a top plan view of the brush head of the toothbrush of FIG. 1;

FIG. 3 is a longitudinal sectional view of the brush head taken along the line B-B of FIG. 2 parallel to the longitudinal axis of the toothbrush;

FIG. 4 is a longitudinal sectional view of the brush head of FIG. 2 taken along the line A-A of FIG. 2;

FIG. 5 is an enlarged side view of one of the outer, longer bristle tufts of FIG. 3 in an enlarged schematic representation showing the bevel angles of the tuft;

FIG. 6 is a schematic cross-sectional view of a self-fanning bristle according to an embodiment having three laterally protruding longitudinal ribs;

FIG. 7 is a schematic cross-sectional view of a self-fanning bristle according to another embodiment having four laterally protruding longitudinal ribs;

FIG. 8 is a fragmentary schematic view of the toothbrush head of the toothbrush of FIG. 1, showing the tilting of the bristle support as well as the inclination of the working surface of the bristle field in opposite direction, with the brush head being illustrated as positioned against a tooth during brushing;

FIG. 9 is a schematic view of the resulting velocity or kinematical relationships during a bristle's poking motion, showing in the partial view (a) a bristle standing perpendicularly on the tooth surface, while the partial view (b) shows a bristle positioned at a slant as a result of the titling of the bristle support;

FIG. 10 is a schematic view of the deflecting movement of a bristle as it is positioned against a tooth surface, with the partial views (a) and (b) showing a bristle as positioned perpendicularly against the tooth surface, whilst the partial views (c) and (d) show a bristle positioned at a slant according to the invention, in which the bristle bends away instead of presenting the buckling column case;

FIG. 11 is a schematic vie of the cleansing effect of a bristle in flexed condition, with the partial view (a) showing the cleansing effect of a bristle not driven in a poking motion, whilst the partial view (b) shows the cleansing effect of a bristle driven in a poking motion; and

FIG. 12 is a fragmentary schematic view of the toothbrush head of the toothbrush similar to FIG. 8 according to a further embodiment, showing the tilting of the bristle support, with the axis of rotation being eccentrically arranged relative to the bristle field main axis according to the partial view 12(a) and being tilted according to the partial view 12 (b).

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

According to the present disclosure, a brush head for an electric toothbrush is provided. In one embodiment, the bristle support is arranged with its bristle field, which is drivable at least in a reciprocating poking motion along a poking axis and optionally additionally spatially in an oscillatory rotational motion about an axis of rotation, in a special way such that during the poking motion the bristle tufts do not strike the tooth or gum surface at exactly right angles but nevertheless may affect self-centering of the bristle field when the rotating/pivoting motion about the axis of oscillation or rotation. According to one embodiment, the bristle support with its bristle field is arranged at a tilt relative to the brush head longitudinal axis, such that the main axis of the bristle field is inclined at an acute angle to a perpendicular upon the toothbrush and/or brush head longitudinal axis, whereas the working surface is inclined in opposite direction to the tilt of the bristle field main axis such that a plane lying onto the working surface is sloped at an acute angle to a plane perpendicular to the bristle field main axis.

By tilting the bristle support out of its “straight” orientation as conventionally used on bristle supports drivable spatially, i.e., in an oscillatory rotational motion and a poking motion, where the main axis of the bristle field extends at right angles to the toothbrush longitudinal axis, into a slightly tilted, “skew” orientation, a pleasant brushing sensation even on the gums is achievable in spite of the poking motions of the bristle field, because the bristle field with its main axis and hence the majority of the bristles are positioned against the surface to be cleaned at a slight inclination. This largely avoids the buckling column case in which the reaction forces of the poking motion are introduced into the bristles exactly in longitudinal direction, and can only occur on surfaces which happen to be inclined at the corresponding angle. This is however a relatively rare occurrence because the user typically positions the toothbrush at right angles against the teeth. To avoid the buckling column case, it is helpful to have also the poking axis at a tilt relative to the brush head longitudinal axis, i.e. inclined at an acute angle to the perpendicular upon the brush head longitudinal axis. In particular, the poking axis may extend parallel to the perpendicular upon the brush head longitudinal axis. The desired self-centering effect may nevertheless be achieved when the oscillatory rotational motion is provided which ensures that the toothbrush rests snugly and smoothly against the tooth to be cleaned. The inclination of the working surface of the bristle field in the opposite direction to the tilt of the bristle field main axis helps the user to put the working surface correctly onto the teeth and to bring the working surface into snuggly fitting contact with the teeth surface despite the tilt of the bristle field main axis.

The bristle field main axis basically extends parallel to the longitudinal axis of the bristles or bristle tufts when all bristles or bristle tufts extend in the same direction. Nevertheless, even if some of the bristles or bristle tufts are arranged at an inclination to other bristle tufts, there is still a bristle field main axis. In such a case where the bristle field includes tilted bristle tufts, the bristle field main axis is in parallel with the longitudinal axis of the majority of bristle tufts. For example, if inner bristle tufts extend in parallel with each other, whereas some outer bristle tufts are inclined to diverge from each other, the bristle field main axis is still in parallel with the longitudinal axis of the inner tufts. Moreover, even if the bristle field includes a plurality of differently inclined bristle tufts, there is still a bristle field main axis which is defined to have the minimum angular deviation from all bristles and the longitudinal axis thereof, thus representing a sort of average axis of longitudinal extension which can be determined, for example, by replacing the axes of each pair of neighboring tufts by a replacement axis inclined to each of the neighboring tufts at the same angle, and repeating such replacement steps with the replacement axes until only one last replacement axes is achieved.

The aforementioned plane lying onto the working surface and sloped and inclined to the bristle field main axis corresponds to the working surface if the bristle field has a flat working surface. In an embodiment where the working surface is slightly concave, the plane lying onto the working surface is defined by the outer bristle tufts forming the edge of the concave working surface so that the aforementioned plane is a sort of cover plane. Additionally or in the alternative, the plane lying onto the working surface can be determined to represent an average slope of the working surface when viewing the bristle field in a direction perpendicular to the longitudinal axis of the tooth brush and perpendicular to the aforementioned bristle field main axis. In particular, the plane lying on the working surface may correspond to a plane tangential to the concave working surface in the deepest point thereof.

In a further embodiment, the bristle support with the bristle field arranged on it is tilted relative to the toothbrush or brush head longitudinal axis in such a way that the main axis of the bristle field which extends at right angles to the surface of the bristle support and/or parallel to the majority of bristle tufts is inclined at an angle of between about 2.5° to about 25°, in another embodiment between about 3° and about 17°, to a perpendicular drawn upon the toothbrush or brush head longitudinal axis. Already at relatively small angles of tilt of more than about 2.5°, in another embodiment more than about 3°, the problematical nature of the buckling column during the poking motion of the bristle field and the resultant high prodding forces can be reduced significantly which conveys a pleasant brushing sensation. On the other hand, in cases where the bristle supports are not too sharply tilted there results the desired centering motion which, at angles of tilt exceeding at least about 17° and in another embodiment at least about 25°, would experience a steep decline which would render the handling of the toothbrush difficult.

For example, the angle of inclination of the main axis of the bristle field to the perpendicular upon the toothbrush or brush head longitudinal axis may amount to about 8°+/−3°, whereby a particularly good compromise is achieved between a gentle brushing sensation on the one hand and ease of handling with high brushing performance on the other.

In order to reduce the usual disagreeable side effect of the poking motion, i.e. dancing around of the bristle field, the working surface is inclined in opposite direction to the tilt of the bristle support as mentioned before. This enables the bristle support to be provided with a more pronounced tilt at a more pronounced inclination of the bristle field main axis, which in respect of the seating engagement of the bristle field with the tooth surface is compensated for by the inclined position, in opposite direction, of the working surface of the bristle field. By providing the working surface with a slant not parallel to the bristle support surface, the working surface of the bristle field continues to rest snugly against the tooth surface even if the bristle field with its main axis exhibits a more pronounced tilt. In this arrangement, the slant of the working surface of the bristle field may generally vary, with “slant” not necessarily meaning an inclined plane. Rather, a curved working surface, for example, a working surface curved in groove shape, may be provided, the term slant then being understood to mean a groove configuration differing in height towards different sides, or the slant being understood to mean a secant or tangent or some other surface inclination reflecting or characterizing the surface shape by approximation.

In one embodiment, the angle of the inclination of the working surface, which defines in the aforesaid manner the slant also of a curved surface, where applicable, relative to a perpendicular upon the bristle field main axis is smaller than the angle of inclination of the bristle field main axis to a perpendicular upon the toothbrush or brush head longitudinal axis. If the bristle support with the bristle field affixed to it is tilted in such a way that the bristle field main axis is inclined at an angle of about 8°+/−3° to the perpendicular upon the toothbrush or brush head longitudinal axis, in an advantageous embodiment of the invention the slant of the working surface of the bristle field may have an angle of inclination of between about 1.5° and about 4.5°, in another embodiment about 3.5°+/−1°, relative to a perpendicular upon the bristle field main axis. A very gentle brushing sensation on the one hand and ease of handling with self-centering effect as well as a high cleaning performance on the other hand are thereby achieved.

In a further embodiment, the angle of inclination of the working surface of the bristle field relative to the perpendicular upon the bristle field main axis amounts to between about 25% and about 65%, in another embodiment about 40%, of the angle of inclination of the bristle field main axis relative to the perpendicular upon the toothbrush longitudinal axis.

The bristle support may be generally tilted to different sides. For example, it would be generally possible to tilt the bristle support towards the toothbrush handpiece so that, as seen looking from the toothbrush handpiece, the surface of the bristle support carrying the bristles can be seen.

In one embodiment, the bristle support is tilted away from the toothbrush handpiece, such that an obtuse angle is provided between the bristle field main axis and a section of the toothbrush or brush head longitudinal axis on the side close to the toothbrush handpiece. In other words, given a horizontal orientation of the toothbrush longitudinal axis, an end of the bristle support on the side close to the toothbrush handpiece or a portion of the bristle field arranged there lies at a higher level than an end of the bristle support on the side remote from the toothbrush handpiece or a portion of the bristle field arranged there. The bristle support and/or the bristle field may generally have various outer contours, with the bristle support being in particular of a round configuration. In one embodiment, the bristle support is not circular but of a shape deviating from the circular. For example, the bristle support may be of an oval or elliptical configuration or slightly flattened in a similar way. Alternatively or in addition, at least the outer row or the outer ring of bristle tufts may be arranged on an oval or on an ellipse or on a ring flattened in similar manner.

As seen looking at the top of the bristle support, the bristle tufts are arranged symmetrically relative to the main axes of the bristle support and/or rotationally symmetrically, in such a way that the bristle tufts or their points of attachment on the bristle support are engageable one into the other by a turn through 180 degrees.

Alternatively or in addition, the bristle field may however have an asymmetrical contour as seen in a side view, for example, in a direction transverse to the toothbrush longitudinal axis, particularly in such a way that the height profile rises more intensively towards one side than towards the other side so that the working surface of the bristle field as defined by the free ends of the bristles exhibits a slant and does not extend parallel to the bristle support surface.

In a further embodiment, the bristle field has a central depression in the working surface defined by the free ends of the bristle tufts, which may have a groove-shaped bottom curved in one direction and substantially straight in the direction perpendicular thereto. Through such a substantially uniaxially curved depression in a middle portion of the bristle field or its working surface, it is possible to achieve not only a better holding of the dentifrice or a similar, gel-type dental cleansing agent but above all a better cleaning effect on the teeth accompanied by a more agreeable, gentler cleaning sensation. The contour of the working surface, which rises to opposing circumferential sides, nestles better against the lateral tooth flanks which, so to speak, are enveloped in a snug fit so that in particular the sections of the tooth flanks adjoining the interproximal spaces are better cleaned.

Unlike bristle fields with plane depressions in the middle, it is not necessary for the innermost, i.e., central tufts, to bend away first. Rather, the bristle tufts rest in a snug fit against the lateral flanks of the teeth without bending away. In addition, a gentler cleaning sensation results, for example, when moving the brush head from one tooth to the next, because due to the varying tuft height also in the central area individual tufts are pushed away in succession when the brush sweeps over a tooth flank, the brush head being pushed, so to speak, along the curved surface of the depression around the flank of the next tooth without the brush head falling into the depression. For example, with rotational driving of the bristle field, there results in addition a gentle wiping motion because the tufts hugging the tooth flank are more intensively bent as the distance from the axis of rotation increases.

The groove-shaped curvature of the depressed, central portion of the bristle field surface can be achieved generally in a variety of ways. For example, a correspondingly curved bristle support could be provided while the tufts are of uniform length. However, in a further embodiment, the tufts and in particular the inner lying tufts vary in their length such that they define with their free ends said groove-shaped curvature. For example, the length of the inner lying tufts can increase in the direction of the curvature of the working surface defined by the free ends with increasing distance from a center point of the bristle support, such as to define said groove-shaped curvature of the central depression. Through such a varying length of the tufts it is possible to achieve a gentle cleaning sensation and a gentle movement of the bristle field over the teeth because the further projecting bristles are able to bend away more easily on account of their greater length.

In order to obtain a most continuous curvature of the surface of the central depression, the free ends of the inner tufts, which define said working surface in the region of the depression, do not have end surfaces extending parallel to the bristle support but end surfaces which are inclined at an acute angle to the surface of the bristle support, with different inner tufts having differently inclined end surfaces, such that the differently inclined end surfaces define in mutual complementation the path of said groove-shaped contour of the central depression. For example, the inclination of the end surfaces of the free ends of the tufts can be made increasingly more pronounced as the distance of the tufts from the center of the bristle support increases, thus resulting in an increasingly steeper wall of the groove-shaped bottom in the direction of the circumferential edges of the bristle field.

Generally the tufts may form a plane surface at their free ends. In this case the inner tufts define the groove-shaped curvature in the form of a chine-type construction with a slant increasing in steps from tuft to tuft. However, in one embodiment, the free ends of the inner tufts can have at their free ends an end surface which is not plane but arcuately curved such that the mutually complementing free ends of neighboring tufts define a continuously curved enveloping surface which forms the previously mentioned groove-shaped depression. The curved end surfaces of the individual tufts are uniaxially curved, i.e., they are in themselves already curved in groove shape, so that they run in a straight line in one direction while having a curvature in a direction perpendicular thereto.

The groove-shaped curved bottom of the central area of the working surface of the bristle field can be generally of a symmetrical configuration, i.e., extending substantially parabolically. In this case, the inner tufts rise with their free ends at a substantially equal rate to opposing circumferential sides of the bristle field. In one embodiment, the groove-shaped curvature may also be part of a cylinder shell whose radius of, for example, about 10 mm to about 14 mm determines the shape of the groove-shaped curvature.

In another embodiment, provision can also be made for an asymmetric path of the curvature of the central depression in the working surface of the bristle field, in which case a banana-shaped groove curvature can be provided. In this arrangement, the tufts defining the central depression in the working surface of the bristle field rise unequally to opposing circumferential sides so that the one upper edge of the groove-shaped depression is higher than the opposing edge. Among other things, this can be used, for example, to compensate for the tendency of users to position the brush head against the tooth flanks in a not exactly tangential but in a slightly V-shaped orientation. In this example, the asymmetric gradient is oriented in the above-mentioned manner in a direction opposite the tilt of the bristle support or the bristle field main axis.

To achieve an even more greatly improved interproximal cleaning effect, in one embodiment, the outer, longer or higher tufts have at least one bevel on their free end surfaces. For example, the lateral edges of the end surfaces can be beveled in the manner of a chamfer. In one example, the longer outer tufts can better penetrate into the interproximal spaces. In another example, the brush head can be moved more easily and more gently from one tooth to the next because the bevels of the circumferentially outer lying tufts raise the bristle field in the manner of a wedge-shaped inclined surface onto the next tooth flank.

In this arrangement, the outer, longer tufts can be generally beveled towards both the inner side and the outer side. However, in one embodiment, only one bevel is provided on one of the sides of the respective tuft so that a sufficiently wide, non-beveled end surface remains, as a result of which a cleaning effect is achieved equally in the interproximal spaces and on the tooth flanks. In another embodiment, the outer edges of the free ends of the tufts, i.e., the edges facing away from the inner tufts, are beveled. As a result, the brush head can be pushed particularly gently from one tooth to the next. In one embodiment, the inner-side plane surface of the outer tufts is vertically offset relative to the inner tufts forming the groove-shaped depression, thereby forming a jump in height from the central depression to the longer bristles at the edge. This enables a high self-centering effect to be accomplished on the one hand while achieving a particularly effective interproximal cleaning effect on the other hand.

Alternatively or in addition, the inner-side edge of the end surface of said outer, longer tufts can also be beveled. As a result, the working surface of the bristle field rests with a particularly snug fit against the round-bodied tooth flanks. The inner side bevel is a continuation, so to speak, of the groove-shaped curved depression in the center of the working surface of the bristle field.

Depending on the application and configuration of the tufts, the bevel on the circumferential, longer tufts can be variously pronounced. A good cleaning effect both between the teeth and on their surfaces can be achieved when said bevel of the circumferential tufts is inclined at an angle of approximately about 20° to about 60° relative to the non-beveled end surface of the tuft. Generally, the depth of the bevel can be variously selected, with an example between easy entry into the interproximal spaces and remaining cleaning capability on the tooth flanks being accomplished if said bevel extends over approximately about 25% to about 75% of the width of the tuft at its end. In this context, “width” is understood to mean the dimension of the tuft vertically to its longitudinal axis and transversely to the longitudinal direction of the bevel.

Particularly effective are the circumferential, longer outer tufts, for example, in combination with said bevels, when said tufts are inclined at least with their outer side towards the outer circumferential side at an acute angle relative to a vertical on the bristle support, at an angle in the range from about 1.5° to about 15°, in another embodiment from about 3° to about 10°, approximately. As a result, the tufts acquire a reduced resistance to buckling in one direction during the to and fro motion of the brush head, thus giving rise to better insertion into the interproximal spaces.

In an embodiment, the longer outer tufts have a cross-sectional area that grows larger towards their free ends and/or lateral flanks that spread apart as they progress from the bristle support. For example, the circumferential outer tufts can be trapezoidally shaped as seen in a longitudinal sectional view, such that the free ends of the tuft are wider than its base on the bristle support. In one example, such a trapezoidal configuration lends the tufts a larger working surface on their free ends. In another example, the fan-type spreading apart enables the bristles within a tuft to move relative to each other with greater ease, which results on the whole in a better adaptation to the tooth contour and an improved cleaning performance. For example, with lateral bevels of the free ends of the tufts, the tufts acquire favorable geometrical proportions with more tangible edges which nestle better against the boundary contours of the teeth.

The trapezoidal configuration of the outer, longer tufts is asymmetric in relation to a vertical on the bristle support. For example, an inner flank of the tufts, which faces the inner tufts, can extend substantially vertically to the surface of the bristle support while an outer side of the respective tuft, which faces away from the inner tufts, is inclined towards the outer side at an acute angle to a vertical on the bristle support. Accordingly, the outer flanks standoff outwardly at an angle while the inner flanks stand straight, that is, they are aligned substantially vertically to the bristle support surface.

On the elongated bristle tufts, the previously mentioned bevel on the free end of the tuft extends parallel and/or tangentially to the longitudinal axis of the elongated end surface of the tuft. In one embodiment, longer outer tufts are provided on the outer circumference in opposing circumferential sectors on opposing circumferential sides so that the central depression in the working surface of the bristle field extends between the opposing longer circumferential tufts. In this arrangement, the longer, outer tufts are not provided along the entire circumference of the bristle field but only in limited angular sectors of less than about 60° per sector angle, whereas no longer, elevated outer tufts are positioned circumferentially in intermediate sectors in which the groove-shaped curved depression in the central area is at its deepest. The groove-shaped central depression extends, so to speak, transversely across the entire bristle field. In said sectors in which the groove-shaped depression is at its deepest, the outer circumferential tufts are adapted to the configuration of the groove-shaped depression contour or they form part of it.

The brush head can be generally driven in a variety of ways. Different drive kinematics can be implemented depending on the configuration of the toothbrush and its drive. In one embodiment, the driving motion comprises an oscillatory rotational motion about an axis of rotation which extends through the bristle support. In another embodiment, the axis of rotation can extend vertically to the plane of the bristle support through its center point or center of gravity. However, according to an alternative embodiment, it is also possible for the axis of rotation to be positioned eccentrically so that motion components of different magnitude are generated on different circumferential sides of the bristle field.

In one embodiment, the eccentricity applies to the longer, outer tufts, that is, the axis of rotation is displaced parallel to a connecting line through the opposing, outer, longer tufts. Depending on the configuration of the bristle field, the eccentricity can be variously pronounced, with a good compromise between cleaning movements of desirably different size on different circumferential sides on the one hand and still tolerable vibrating movements on the other hand being achieved when the axis of rotation divides a diameter line of the bristle support in a length ratio of from about 55% to about 45% and in another embodiment from about 70% to about 30%.

Alternatively or in addition, it is possible for the axis of rotation of the bristle support to be inclined at an acute angle to the plane defined by the support, with the angle of inclination being in the range from about 89° to about 65°, in another embodiment from about 88° to about 82°, relative to the plane of the bristle support. As a result it is possible, in conjunction with the groove-shaped curved surface profile of the bristle field, to superimpose a poking motion upon the rotary motion. In one example, the axis of rotation is tilted such that the bristle field is tilted away from the handpiece of the toothbrush.

Given a rotary oscillation of the bristle field, in another embodiment, the end surface of the circumferentially outer, longer tufts, which looks elongated in the plan view, extends in an arc about the axis of rotation, for example, in a circular arc about the axis of rotation.

In one embodiment, the previously mentioned bevels on the outer ends of the longer, outer tufts can nevertheless extend in a straight line, for example, substantially tangentially to the arcuately curved, elongated end surface of the tufts. In one example, this simplifies the production of the tufts. In another example, this results in a circumferentially varying width of the bevels and, concomitant thereto, of the non-beveled end surfaces, which in the manner of wedge surfaces can cause the corresponding tufts to be continuously inserted into and withdrawn from the interproximal spaces.

However, according to an alternative embodiment, it is also possible for the bevels to extend equally in an arcuate curve around the axis of rotation, for example, such that the bevels and/or the remaining, non-beveled end surfaces of the tufts have a contour and width that is constant in circumferential direction. As a result, it is possible to achieve a particularly gentle contacting of the tufts with the tooth flanks and a favorable penetration into the interproximal spaces.

The outer, longer tufts enclose the inner tufts along a distance covering from about 25% to about 75%, approximately, of the circumference of the bristle field or the bristle support.

The inner tufts, which with their free ends define the central depression in the working surface, can form with their free ends a substantially continuous surface such that an in actual fact continuous groove-shaped depression results. In one example, it is thus possible to achieve a nestling around the full surface of the tooth flanks and hence a cleaning effect covering a large area. In another example, it has a beneficial effect on the positioning of the dentifrice or the tooth cleaning agent, which is held better on the working surface of the bristle field and does not flow so easily between the tufts down onto the bristle support.

In an alternative embodiment, the inner tufts can form with their free ends separate end surfaces, as a result of which a better discharge of dislodged debris is achievable.

To reduce the prodding motions against the gums still further and create a particularly agreeable brushing sensation, the bristles provided in the bristle field, may have their ends or portions of their ends fanned. As a result, the bristle tips have several fraying thin ends providing a large area for snugging up against the tooth surfaces. To achieve an adequate cleaning action, such fanned bristles are mixed with non-fanning bristles.

In a further embodiment, the corresponding bristles, that is, the fanning bristles, may be of the self-fanning type, such that the cleaning forces acting on the bristles during normal cleaning lead to a splitting open of the bristle at its free end. This obviates the need to provide complex splitting processes and corresponding splitting machines for manufacturing the toothbrush. The fanning bristles with the laterally protruding longitudinal ribs are grouped in corresponding tufts with non-self-fanning bristles such that a mixture of fanning and non-fanning bristles exists in the corresponding tuft. This enables a good nestling of the bristles around the tooth surface, a good distribution of cleaning agent and an agreeable cleaning sensation to be combined with a high cleaning performance with regard to the removal of plaque. Also, a high density of bristles can be achieved in a tuft and hence on the bristle support of the brush head.

In one embodiment, the mixed tufts comprising both fanning bristles with lateral longitudinal ribs and normal bristles devoid of longitudinal ribs are arranged in an inner area of the bristle field of the brush head while tufts comprising non-fanning bristles are provided on an outer edge of the bristle field, in which arrangement the outer tufts can have a greater length and/or height and/or diameter than the inner lying tufts, such that a particularly effective cleaning of the interproximal spaces can be achieved with the outer tufts made of non-fanning bristles. At the same time, the fanning bristles in the inner area of the bristle field ensure an effective cleaning of the tooth flanks.

In an embodiment, the bristle body including its core section is free of points of breaking, i.e., it has a homogeneous material structure and microstructure over its entire cross-section. The self-fanning construction can be achieved generally in a variety of ways. In one embodiment, the bristles are shaped in a special configuration. For example, the bristle body can be shaped such that longitudinal ribs of a suitable configuration protrude laterally, which then split open at the bristle ends under the action of the cleaning forces.

The body of such a bristle may generally have a varying number of longitudinal ribs. In one embodiment, three or four longitudinal ribs are provided. The longitudinal ribs of the brush body generally can have different geometries. In one embodiment, the cross-section of the bristle body is in actual fact cloverleaf-shaped and/or the longitudinal ribs have an outer contour which corresponds to a pitch cylinder.

Alternatively however, the longitudinal ribs can have other outer contours. For example, the outer contours can correspond to pitch cylinders having a triangular cross-section, a rectangular cross-section, a rhombic cross-section or a hexagonal cross-section. In one embodiment, all of the longitudinal ribs have a mutually identical outer contour in order to achieve uniform fanning.

The bristles with longitudinal ribs can be generally added in a varied mixture ratio to the non-fanned, normal bristles. Depending on the application, it is possible to use more fanning bristles or more non-fanning bristles. A good compromise with regard to the removal of plaque on the one hand and to hugging the tooth surfaces and distributing the cleaning agent on the other hand is achieved in a further embodiment by using about 50%+/−10% self-fanning bristles with laterally protruding longitudinal ribs on the one hand and about 50%+/−10% non-fanning normal bristles on the other hand per mixed tuft.

Generally, the non-fanning bristles can have various cross-sectional geometries. In one example, they are devoid of longitudinal ribs, with a basic geometrical cross-sectional shape such as rectangular or hexagonal. The bristles provided as non-fanning bristles are in particular bristles with a round, in particular circular, cross-section.

In one embodiment, the use of the fanning bristles in a bristle field on which tufts of a large cross-sectional area are concentrated at the outer edge of the bristle field and/or in its central area and tufts of a small cross-sectional area are provided between the large-area tufts at the edge and in the center on a middle ring of tufts. For example, within the elongated tufts on the outer ring there are arranged on a middle ring several tufts having a cross-section smaller than the cross-section of the elongated tufts, and within these small tufts on the middle ring there is provided at least one tuft with a cross-section larger than the cross-section of the tufts on the middle ring. By virtue of this rhythmic alternation of tuft cross-sections from inside to outside, it is possible to achieve a high bristle density and to better prevent a collision of the fastening means.

Furthermore, advantages also arise with regard to the cleaning effect. Among other things, the dentifrice usually applied in the center of the bristle field is held better on the working surface. In one embodiment, the tufts of the middle ring and the innermost tufts are equipped with the fanning bristles.

In a further embodiment, bristle tufts of various cross-sectional shapes are arranged on the at least one middle ring of bristles. For example, on the at least one middle ring bristle tufts may be provided which have an approximately square tuft cross-section. Alternatively or in addition, the middle ring may also include bristle tufts with a round cross-section, in particular a circular cross-section. If both angular, in particular square, and round, in particular circular bristle tufts are arranged on the middle ring, they are concentrated in different sectors each. To do this, a variety of options exist in general. According to one embodiment, round bristle tufts are arranged on the middle ring in opposing sectors, which in the non-deflected neutral position of the bristle support contain the toothbrush longitudinal axis. By contrast, the angular bristle tufts of the middle ring are arranged in opposing sectors of the bristle support which in the bristle support's neutral position are arranged symmetrically to a transverse axis.

Regardless of their different cross-sectional shapes, the bristle tufts of the middle ring have at least by approximation roughly the same area of cross-section, with the areas of cross-section varying in a range of less than about +/−25%.

Compared to the areas of cross-section of the bristle tufts of the middle ring, the outer, elongated bristle tufts on the outer ring and, according to another embodiment, also the at least one innermost tuft in the center of the bristle field have an area of cross-section at least twice as large. In this arrangement, on the outer ring of the bristle field there may be arranged advantageously several opposite lying pairs of elongated bristle tufts. For improved adaptation of the bristle configuration to the different cleaning tasks in different areas of the bristle field, the outer ring may include differently designed pairs of elongated bristle tufts which differ in respect of their bristle length and/or height and/or cross-sectional area.

Various configurations are generally possible in this context. According to one embodiment, opposing sectors of the bristle support, which in its non-deflected neutral position contain the toothbrush longitudinal axis, include longer bristle tufts and/or elongated bristle tufts of greater cross-sectional area than the tufts in sectors oriented at right angles thereto in a direction transverse to the toothbrush longitudinal axis.

In addition to the elongated bristle tufts, the outer ring may provide further bristle tufts of a not elongated contour, which may have an approximately round or square cross-section of a cross-sectional area smaller than the cross-sectional area of the elongated bristle tufts.

In one embodiment, the central area of the bristle field includes two equally elongated bristle tufts whose longitudinal axis, that is, the longitudinal dimension of the elongated cross-section, is aligned parallel to a main axis of the bristle support. For example, the innermost bristle tufts may have their longitudinal axes oriented parallel to the toothbrush longitudinal axis in the non-deflected neutral position of the bristle support and/or oriented towards the elongated bristle tufts of the outer ring which on the outer ring have the greatest height and/or greatest cross-sectional area.

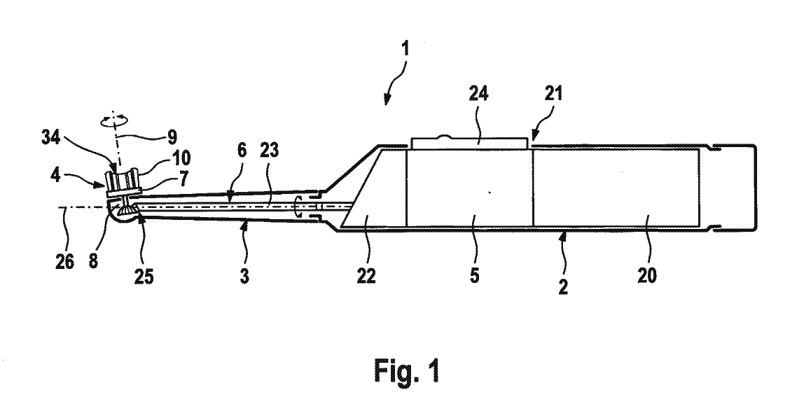

The toothbrush 1 shown in FIG. 1 includes a handpiece 2 and a brush head 4 adapted to be coupled to it. To be more precise, the brush head 4 is adapted to be coupled to a neck 3 of the toothbrush 1 connected to the handpiece 2, for example, by positive-engagement connecting elements, the neck being constructed in the form of a hollow brush tube. However, it would also be possible for the brush head 4 to comprise the neck 3 or at least part of it and to be adapted to be coupled with it to the handpiece 2. The handpiece 2 accommodates in its interior an energy source 20, for example, in the form of a rechargeable battery, a motor 5, for example, in the form of an electric motor, and a control device 21.

In the embodiment shown, the rotary motion of the motor 5 is translated by means of a gearing 22 into an oscillatory rotational motion of a drive shaft 23 which extends through the neck 3 to the brush head 4. The toothbrush 1 can be activated and deactivated with a switch 24 mounted on the handpiece 2.

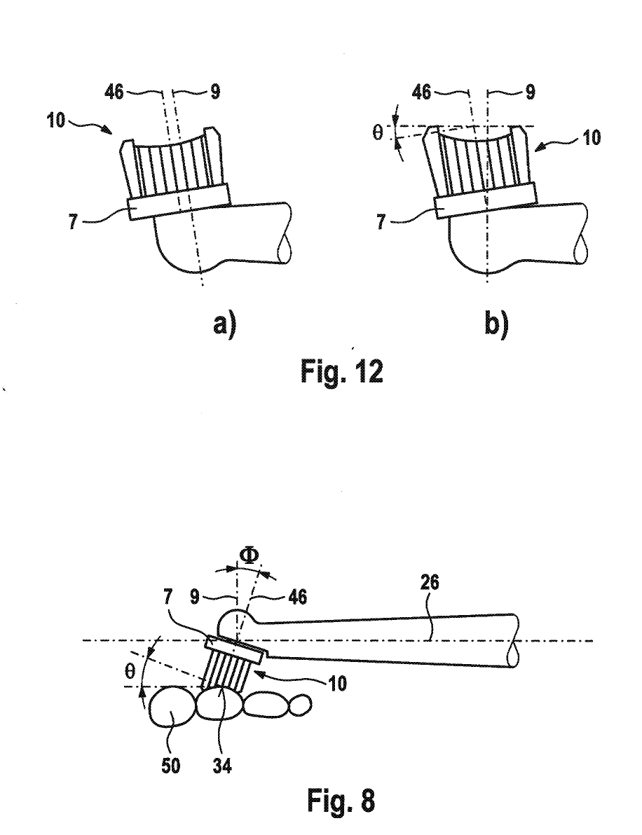

In known manner using a suitable gearing (a bevel gearing 25 unlike in the shown embodiment), at the end of the drive shaft 23 the brush head 4 is made to make an oscillatory rotational motion about an axis of rotation 9 which extends substantially in a direction transverse to the toothbrush longitudinal axis 26. As this occurs, the angular range swept by the bristle support 7 of the brush head 4 has a value in the range of about ±35 °±5°, approximately, with an oscillation in the range from about ±10° to about ±100° being also possible. The oscillation frequency can vary and lie, for example, between about 10 Hz and about 100 Hz. In the embodiment shown in FIG. 1, the axis of rotation 9 forms a right angle with the toothbrush longitudinal axis 26. In addition, a drive of the brush head 4 is provided in a third dimension for its pulsing motion substantially (depending on whether or not further spatial motion components are added resulting from additional tilts of the brush head, where applicable, depending on the pivot position) in the direction of the axis of rotation or oscillation 46 or in the direction in which the bristle extends. In a special case, the poking axis 48 is thus identical with the axis of oscillation 46, and in other cases it is arranged at an inclination (at an acute angle thereto) or roughly perpendicularly to the toothbrush longitudinal axis 26. Whichever the case, the brush head is driven towards the tooth in an additional poking motion. In the embodiment shown in FIG. 1, the axis of rotation 9 forms an obtuse angle with the toothbrush longitudinal axis 26 because the brush head is arranged at a tilt away from the handpiece 2, as will be explained further below with reference to FIG. 8.

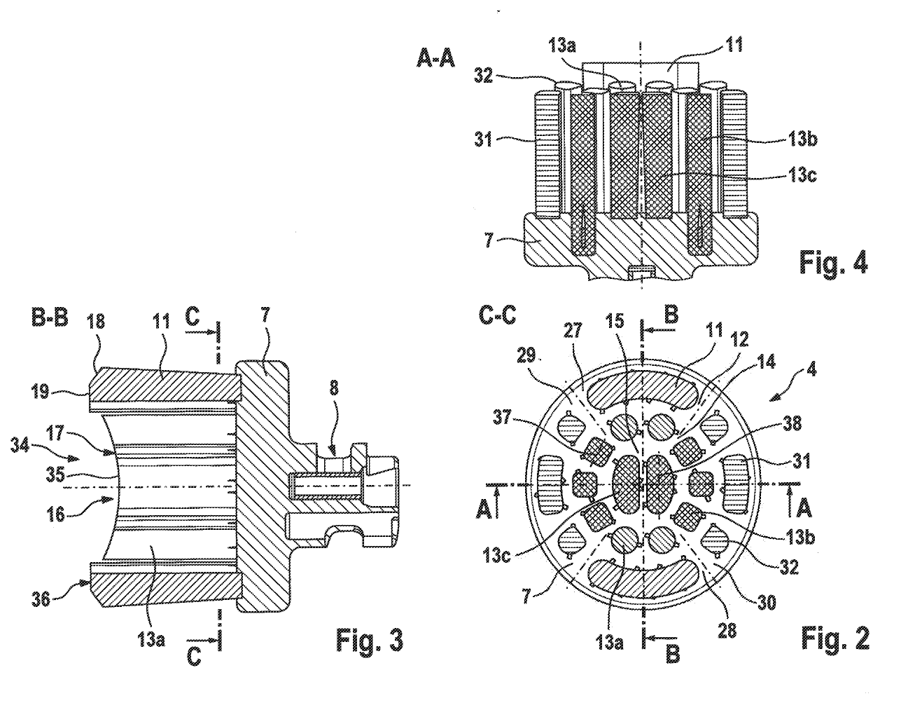

One embodiment of the brush head 4 of the toothbrush 1 is shown in FIGS. 2 to 5. In this embodiment, the bristle support 7 is round, however not circular but slightly oval and/or elliptical, with the longer axis of the oval or the ellipse in the neutral position of the bristle support 7 extending parallel to the toothbrush longitudinal axis 26, and the shorter axis of the oval or the ellipse extending in a direction transverse to it. In FIG. 2, the longer axis of the oval or the ellipse is parallel to the line B-B.

Arranged on the bristle support 7 is a plurality of bristle tufts which are arranged in several rings 12, 14 and 15 and spread over the bristle field 10. Positioned on an outer ring 12 in the embodiment of FIG. 2 are eight tufts, of which four have an elongated contour while another four have a—roughly speaking—round or equilateral cross-sectional contour. The length of the tufts on the outer ring 12 varies, as will be explained in more detail, with longer tufts being provided generally in opposing sectors 27 and 28, which in the initial position of the bristle support 7 contain the toothbrush longitudinal axis 26, than in sectors 29 and 30, which are orientated in a direction transverse thereto or lie in between, as shown in FIG. 2.

As FIG. 2 shows, the tufts 11 and 31 lying on the outer ring 12 on the main axes B-B and A-A, respectively, are elongated in the plan view while the tufts 32 lying in between have an approximately equilateral contour or an approximately cubic or round cross-section. The elongated tufts 11 and 31 extend in an arcuate curve around the axis of rotation 9, as shown in FIG. 2. In this arrangement, the outer tufts 11 sitting on the longer main axis B-B extend over a circumferential section of approximately from about 50° to about 90°, in another embodiment approximately about 70°, while the outer tufts 31 sitting on the shorter main axis A-A extend over a circumferential section of from about 20° to about 45°, and in another embodiment about 30°, approximately.

Positioned on a second ring 15 of tufts, seen from the outside, are a total of ten tufts 13a and 13b, of which some have a circular cross-section and others an angular cross-section. In particular tufts 13a with a circular cross-section are arranged, as shown in FIG. 2, in the sectors 27 and 28 in which the longer outer tufts 11 of the outer ring 12 lie, while angular tufts are provided in the intermediate sectors 29 and 30 of the bristle support 7 on the second ring 14. Also, the length of these tufts 13a and 13b on the second ring 14 varies cyclically from tuft to tuft along the circumference of the ring 14, in such a way that longer tufts are provided in said sectors 27 and 28 than in the sectors 29 and 30 lying on the short main axis.

The round bristle tufts 13a as well as the angular, approximately square bristle tufts 13b of the middle ring 14 have approximately at least about the same area of cross-section regardless of their different cross-sectional contour.

As FIG. 2 shows, to provide favorable space conditions for the securing of the bristle tufts, in a further embodiment, the angular bristle tufts 13b of the middle ring 14, at least some of them, may be turned at an acute angle relative to the main axes A-A and B-B of the bristle support 7 and also relative to the annular contour of the ring 14 on which they are arranged. For example, at least one of the angular bristle tufts, and in another example, each second angular bristle tuft 13b, may have its main axis 37 turned in such a way that the main axis 37 of the bristle tuft cross-section is inclined at an acute angle to a tangent to the middle ring 14. This causes corresponding anchor plates to be turned out of the collision range of other anchor plates. In addition, the flexing action of the bristle field can be made more homogeneous on the whole and in particular less dependent on direction.

Finally, in an innermost area or in a third ring of tufts as seen looking from outside two elongated bristle tufts 13c are provided which extend with their longitudinal axis 38 parallel to the longer main axis B-B. The innermost bristle tufts 13c have a cross-sectional area significantly greater than the bristle tufts 13a and 13b of the middle ring. In the embodiment shown, their cross-sectional area amounts to between about 200% and about 400% of the cross-sectional area of the bristle tufts 13a and 13b of the middle ring 14.

In this arrangement, the innermost bristle tufts 13c are of an elongated configuration so that their longitudinal dimension 38 amounts to more than about 150% of their transverse dimension, in another embodiment from about 150% to about 300%, approximately. In the embodiment shown, the innermost bristle tufts 13c have an outer contour curved in convex shape while an inner contour is straight, with the inner and outer contours being connected by rounded end contours.

In one example, the innermost bristle tufts 13c have their longitudinal axes 38 aligned parallel to the main axis of the bristle support which in the non-deflected neutral position of the bristle support 7 extends parallel to the toothbrush longitudinal axis 26 or a longitudinal center plane passing therethrough.

As FIG. 3 shows, the tufts of the bristle field 10 have their free ends contoured or coordinated with each other with regard to their length and/or height, such that the working surface 34 of the bristle field 10 as defined by the free ends of the tufts has a central depression 16 with a groove-shaped bottom 17 which is curved in one direction and straight in a direction vertical to it. The curvature extends in the direction of the longer main axis B-B or in the direction of the toothbrush longitudinal axis 26 when the bristle support 7 is in its non-deflected neutral position. In a direction perpendicular thereto, which extends parallel to the shorter main axis A-A of the bristle support 7 and/or transverse to the toothbrush longitudinal axis 26 when the bristle support 7 is in its non-deflected neutral position, the depression 16 has a straight contour as shown in FIG. 3.

The central depression 16 can be constructed to be variously deep. In one embodiment, the deepest point of the depression 16 is set an amount of approximately from about 1 mm to about 3 mm, in another embodiment, about 2 mm, deeper than the highest point of the bristle field 10. The groove-shaped contour of the bottom 17 of the depression 16 generally can have different curvatures. In the embodiment shown in FIGS. 3 to 5, a circular-arc-shaped contour with a curvature radius in the range from about 8 mm to about 17 mm, in another embodiment approximately from about 11 mm to about 14 mm, is provided, but this can vary depending on the dimensions and configuration of the bristle field.

As FIG. 3 shows, the end surfaces of the inner tufts 13a, 13b and 13c and the end surfaces of the shorter, outer tufts 31, which likewise combine to define the groove-shaped bottom 17, are not constructed as plane surfaces but are likewise in themselves curved in groove shape. The groove-shaped curved end surfaces 35 complement each other and in combination form said groove-shaped contour of the bottom 17 of the central depression 16. In concrete terms, the inclination of the end surfaces of the inner tufts 13 increases as the distance from the axis of rotation 9 in the direction parallel to the main axis B-B increases, as shown in FIG. 3. In other words, the tufts arranged on the transversally extending main axis A-A are slightly curved at their free ends but nevertheless are aligned substantially parallel to the bristle support surface, while the inclination of the free ends increases as the distance from said main axis A-A increases.

As FIG. 3 also shows, the outer tufts 11 arranged on the outer ring 12 in the sectors 27 and 28 are extended relative to the other tufts or have a greater height such that they project beyond the other tufts. This results in a step in height relative to the central depression 16, as shown in FIG. 3, that is, the central depression 16 in the embodiment shown in FIG. 3 does not merge smoothly with the end surfaces of said outer tufts 11.

The outer tufts 11 in the opposing sectors 27 and 28, which in the neutral position of the bristle support contain the toothbrush longitudinal axis 26, have end surfaces 36 that comprise a flat section 19, which is aligned substantially vertically to the longitudinal axis of the tufts 11, as well as bevels 18, which bevel said end surfaces 36 towards the outside.

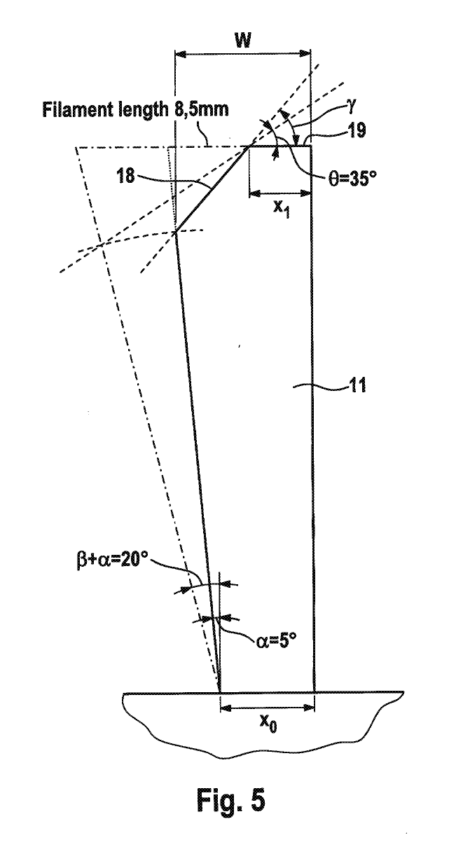

As FIG. 5 shows, the bevels 18 extend at an angle γ in the range from about 20° to about 60°, in another embodiment from about 30° to about 40°, approximately. The bevels 18 are so deep and wide as to cover approximately about 25% to about 75% of the width W of the respective tuft 11. In this case the width W is understood to be the dimension of the tuft vertically to its longitudinal axis and vertically to the longitudinal dimension of the bevel 18, in the region of the free end of the tuft, as shown in FIG. 5. In the embodiment shown in FIG. 5, the bevel thus extends over approximately about ¼ to about ¾ of the width W.

The longer outer tufts 11 are on the whole of a trapezoidal configuration as seen in their longitudinal section. While the inner lying flank of the tuft 11 extends substantially vertically to the plane defined by the bristle support 7, the outer lying flank is inclined towards a vertical on the bristle support 7 at an angle α of approximately about 1.5° to about 10°, and in another embodiment from about 3° to about 5°, such that the cross-section of the tuft 11 increases towards its free end, that is, the tuft becomes wider towards its free end. As a result, a large working surface is obtainable with a limited size of the bristle support 7. In addition, favorable geometrical proportions result at the free end of the tuft 11 in relation to its bevel 18.

In order to embrace the tooth flanks as completely as possible, to distribute the brushing pressure over a wide area and to hold dentifrice or the like on the working surface 34, the tufts occupy with their free ends at least about 35% to about 55%, in another embodiment about 50% or more of the area defined by the bristle support 7. As FIG. 2 shows, the tufts on the outer ring 12 can extend over a circumferential section of from about 200° to about 300°, approximately, when the extension of all tufts is added together. The second ring 14 of tufts, seen from the outside, can extend likewise over a circumference of altogether from about 200° to about 300°, approximately, when the extension of all tufts along the circumference is added together. The innermost tufts can cover with their free ends an area substantially closed over its full surface.

The tufts defining the central depression 16 are equipped at least partly with self-fanning bristles, whereby, for example, the tufts 13a and 13b shown in FIG. 2 of the middle ring 14 and/or the innermost tufts 13c can comprise such self-fanning bristles.

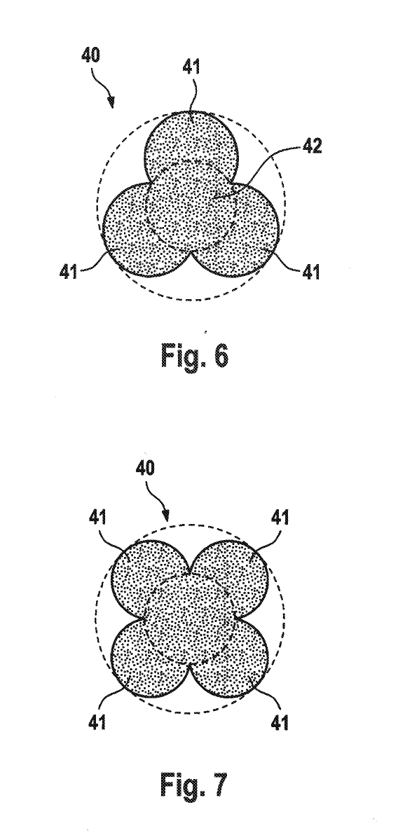

FIG. 6 shows an embodiment of such a self-fanning bristle with a cross-section which generally remains constant over its length and is constructed advantageously to be cloverleaf-shaped, as shown in FIG. 6. The bristle body 40 comprises three laterally protruding longitudinal ribs 41 which protrude from a core section 42 in star shape towards the outer circumferential side. The longitudinal ribs 41 are spread evenly over the circumference. Advantageously, the longitudinal ribs 41 have an outer contour which corresponds to a section of a circular cylinder, approximately, or to some other rounded body.

FIG. 7 shows another embodiment of the bristle. The basic concept corresponds essentially to FIG. 6 so that corresponding reference numerals are used. FIG. 7 differs from FIG. 6 essentially in that instead of three longitudinal ribs 41 four longitudinal ribs 41 are provided and in that the brush body 40 therefore has the cross-section of a four-leaf clover. Here too the longitudinal ribs 41 are spread evenly over the circumference and are equipped with an outer contour which corresponds to a pitch cylinder.

The self-fanning bristles shown in FIGS. 6 and 7 in part in the previously mentioned tufts of the middle ring 14 and the innermost tufts 13c are combined with “normal”, meaning non-fanning bristles, and this in a mixing ratio of from about 50+/−10% to about 50+/−10%, approximately.

As best illustrated in FIG. 8, the bristle support 7 is tilted relative to the toothbrush longitudinal axis in a special way and the bristle field 10, to be more precise, its working surface 34 (shown here in contact with teeth) is provided with an inclination in opposite direction.

The bristle support 7 is tilted relative to the toothbrush longitudinal axis 26, which in assembled condition of the brush head 4 coincides with the brush head longitudinal axis, away from the toothbrush handpiece 2, so that the bristle field main axis 46 is inclined relative to a perpendicular upon the toothbrush longitudinal axis 26 at an angle of inclination Φ of about 8°+/−3°, approximately, as a result of which the bristle field 10 with its main axis 46 “looks away” from the toothbrush handpiece 2.

In one example, the working surface 34 of the bristle field 10, which is defined by the free ends of the bristles, is arranged at a slant, that is, it does not extend parallel to the surface of the bristle support 7, advantageously in such a way as to be inclined in opposite direction to the tilt of the bristle support. The angle of inclination θ of said working surface 34 relative to the perpendicular upon the bristle field main axis 46 is about 3.5°+/−1°, approximately. In view of the fact that said working surface 34 is not plane but includes a groove-shaped curved depression in the manner identified in the foregoing and the bristle tufts arranged on the edge protrude, the inclination is understood to be the inclination of a plane applied by approximation on the working surface, which plane may be determined, for example, by the highest points on the working surface and/or by statistical averaging of the inclined sections.

As FIG. 8 shows, the tilting of the bristle field main axis 46 by angle Φ and the inclination θ of the working surface 34 in opposite direction make it possible on the one hand to achieve an inclined position of the bristle tufts relative to the tooth surface to be treated and to thereby largely avoid the buckling column case, while on the other hand the concave contour of the bristle field 10 or of its working surface 34 sits on the tooth surface with a snug fit, as a result of which the brush centers itself automatically.

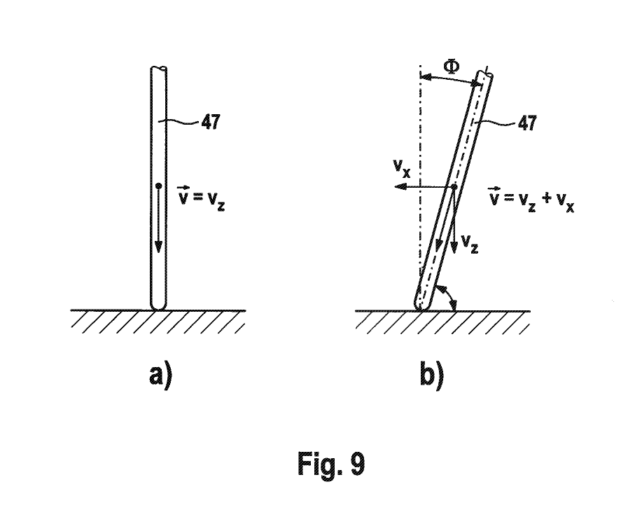

In this context, FIG. 9 illustrates clearly the resulting velocity or kinematical relationships. While FIG. 9 (a) shows a vertically standing bristle on which during a poking motion the velocity vector of the poking motion extends exactly in the longitudinal direction of the bristle, the partial view (b) shows a bristle positioned at a slant on which the poking motion possesses a vertical component relative to the tooth surface and a component parallel to the tooth surface. Corresponding reaction forces are thereby generated. While in the vertical case according to FIG. 9 (a) the reaction forces produced by the poking motion are introduced into the bristle vertically in the bristle longitudinal direction, in the slanting case according to FIG. 9 (b) a component of the reaction force is introduced which extends approximately transversely to the bristle longitudinal axis.

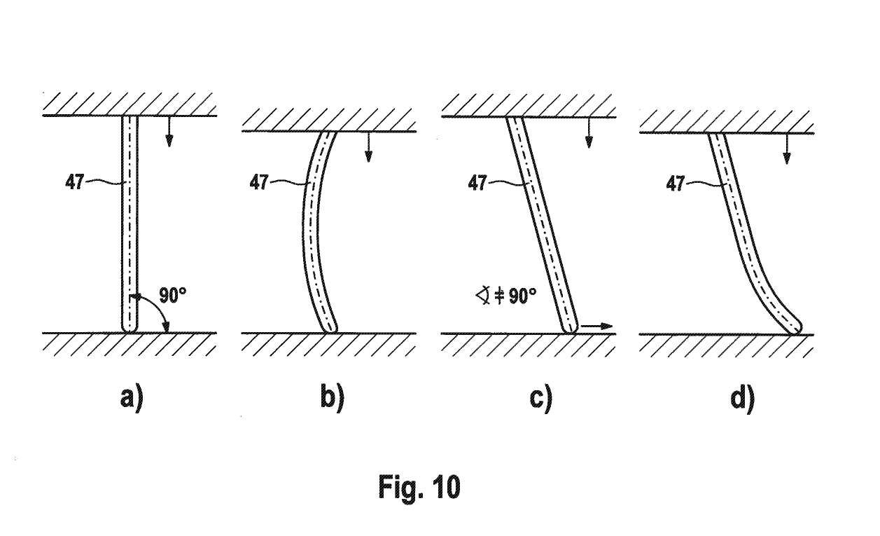

From this result the different buckling or bending cases of the bristle shown in FIG. 10. On the vertically standing bristles according to FIGS. 10 (a) and 10 (b) the bristle bulges similar to a buckling column, while on a bristle positioned at a slant according to the partial views 10 (c) and 10 (d) the bristle bends gently from its free end, whereby the reaction force becomes significantly smaller, producing a significantly gentler cleaning sensation.

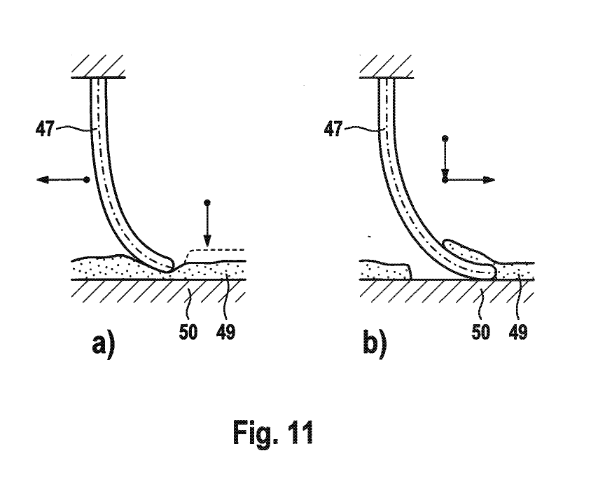

The inclined bristle 47 illustrated in FIG. 11b, which is driven in an oscillating swinging and poking motion, removes the plaque 49 from the tooth 50 more efficiently than the bristle 47 illustrated in FIG. 11a schematically which is only driven in an oscillating swinging motion and is inclined.

As FIG. 12 shows, the axis of oscillation or rotation 9 may also be tilted eccentrically and/or at an acute angle relative to the bristle field main axis 46. According to FIG. 12a, an eccentricity may be provided in the direction of the longitudinal extension of the oval bristle support 7 when in its non-deflected neutral position, or in the direction of the toothbrush longitudinal direction, with the eccentricity not exceeding about 25%, being in particular between about 5% and about 15%, approximately, related to the largest diameter of the bristle support 7. In one example, this produces in the center of the bristle field a stronger relative motion between bristle field and tooth and hence an improved cleaning effect there, while in another example, the self-centering effect is still maintained. According to FIG. 12b it is also possible to tilt the axis of rotation 9 relative to the bristle field main axis, in the range from about 5° to about 15°, whereby a greater spatial component of the driving motion is accomplishable. In one example, the spatial motion component has the same frequency as the oscillation/rotation component (all motions being coupled).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A brush head for an electric toothbrush comprising:
a substantially plate-shaped bristle support carrying a bristle field, the bristle field having a main axis extending substantially perpendicularly to the bristle support and including a plurality of bristles defining with their free ends a flat or concave working surface to be put onto the teeth to be cleaned;
driving and/or transmitting means for driving the bristle support using a reciprocating poking motion along a poking axis and an oscillatory rotational motion about an axis of rotation; and
connecting means for connecting the bristle support with a toothbrush handpiece such that a brush head longitudinal axis extends substantially parallel to a toothbrush handpiece longitudinal axis in connected condition;
wherein the bristle field with its bristle field main axis is arranged at a tilt relative to the brush head longitudinal axis such that the bristle field main axis is inclined at an acute angle of inclination (Φ) to a perpendicular upon the brush head longitudinal axis, and wherein a working surface is inclined in opposite direction to the tilt of the bristle field main axis such that a plane lying onto the working surface is sloped at an acute angle to a plane perpendicular to the bristle field main axis.

2. The brush head according to claim 1, wherein the bristle field main axis is inclined at an angle (Φ) in the range from about 2.5° to about 25° to the perpendicular upon the brush head longitudinal axis.

3. The brush head according to claim 1, wherein the angle of inclination (θ) of the working surface relative to the perpendicular upon the bristle field main axis is smaller than the angle of inclination (Φ) of the bristle field main axis relative to the perpendicular upon the brush head longitudinal axis.

4. The brush head according to claim 1, wherein the bristle support is tilted away from a brush head side facing the toothbrush handpiece in connected condition such that an obtuse angle (ξ) is provided between the bristle field main axis and a section of the brush head longitudinal axis facing the toothbrush handpiece.

5. The brush head according to claim 1, wherein the bristle support is of a shape selected from oval or elliptical and having bristle tufts arranged symmetrically relative to the main axes of the bristle support, in such a way that the points of attachment of the bristle tufts on the bristle support are engageable one into the other by a turn through 180 degrees.
